(19) United States
(12) Patent Application Publication
(10) Pub. No.: US 2007/0278765 A1
(43) Pub. Date: Dec. 6, 2007

(54) FOOTREST

(76) Inventor: Steve Dugan, Minneapolis, MN (US)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/421,876

(22) Filed: Jun. 2, 2006

(51) Int. Cl. B62J 25/00

(52) U.S. Cl. 280/291

(57) ABSTRACT

A footrest includes a tube, a pin and a detent. The tube includes an insert, a skid-proof section formed together with the insert, a tunnel defined therein and an aperture defined in the insert so that the aperture is in communication with the tunnel. The pin includes a recess defined therein between a slope and an upright wall. The detent is positioned in the aperture and the recess. The pin is movable in the tunnel between a first position where the slope pushes the detent so that the detent sticks from the aperture and a second position where the detent retreats in the aperture and the recess so that insert and the detent can be inserted through an aperture defined in a prong of a rear fork of a motorcycle or bicycle.

### BACKGROUND OF INVENTION

1. Field of Invention

The present invention relates to a footrest for use in a motorcycle or bicycle.

2. Related Prior Art

People ride motorcycles and bicycles for communing, delivering goods, racing or just fun. A rider puts feet on two footrests installed on a rear fork of the motorcycle or bicycle. Conventional footrests are installed on the rear forks by fasteners such as threaded bolts and nuts. It requires tools to drive the fasteners. This is however inconvenient.

The present invention is therefore intended to obviate or at least alleviate the problems encountered in prior art.

### SUMMARY OF INVENTION

According to the present invention, a footrest includes a tube, a pin and a detent. The tube includes an insert, a skid-proof section formed together with the insert, a tunnel defined therein and an aperture defined in the insert so as to be in communication with the tunnel. The pin includes a recess defined therein between a slope and an upright wall. The detent is positioned in the aperture and the recess. The pin is movable in the tunnel between a first position where the slope pushes the detent so that the detent sticks from the aperture and a second position where the detent completely retreats in the aperture and the recess so that insert and the detent can be inserted through an aperture defined in a prong of a rear fork of a motorcycle or bicycle.

The primary advantage of the footrest according to the present invention is the convenience in installing and uninstalling without the need of using tools.

Other advantages and features of the present invention will become apparent from the following description referring to the drawings.

### BRIEF DESCRIPTION OF DRAWINGS

The present invention will be described through detailed illustration of two embodiments referring to the drawings.

FIG. 1 is a perspective view of a motorcycle equipped with a footrest according to the first embodiment of the present invention.

FIG. 2 is an enlarged exploded view of the footrest shown in FIG. 1.

FIG. 3 is a cross-sectional view of the footrest shown in FIG. 2.

FIG. 4 is a cross-sectional view of the footrest in another position than shown in FIG. 3.

FIG. 5 is a cross-sectional view of the footrest in another position than shown in FIG. 4.

FIG. 6 is an exploded view of a footrest according to the second embodiment of the present invention.

### DETAILED DESCRIPTION OF EMBODIMENTS

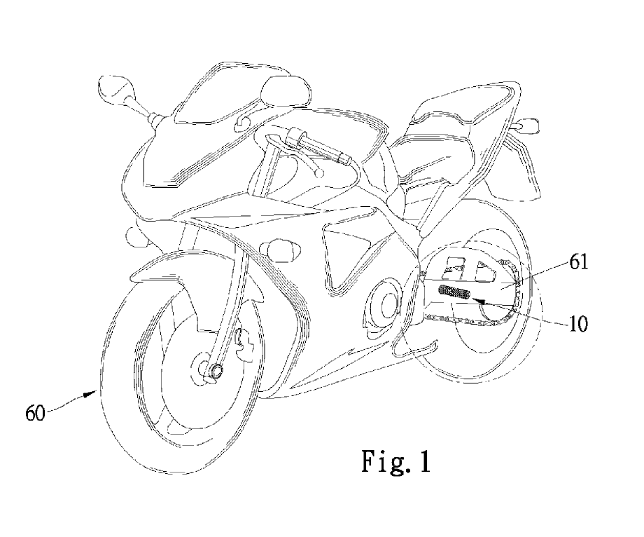

Shown in FIG. 1 is a motorcycle 60 equipped with two footrests 10 (only one of them is shown) according to a first embodiment of the present invention. The footrests 10 can however be used in a bicycle or the like. The motorcycle 60 includes a rear fork with two prongs 61 (only one of them is shown). The footrest 10 is installed on the prong 61. The prong 61 defines an aperture 611 that is circular.

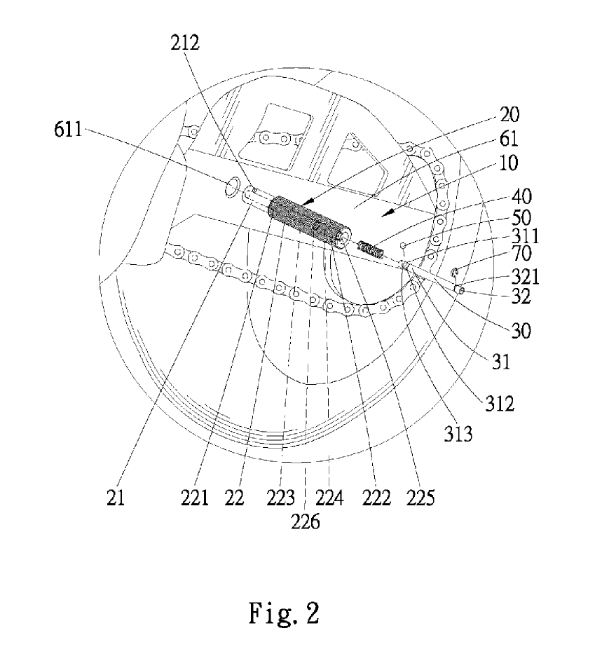

Referring to FIGS. 2 through 5, the footrest 10 includes a tube 20, a pin 30, an elastic element 40, a detent 50 and a clip 70.

The profile of the tube 20 includes an insert 21 and a skid-proof section 22 formed together with the insert 21. The insert 21 includes a circular cross-sectional form corresponding to the circular form of the aperture 611. The diameter of the insert 21 is smaller than that of the skid-proof section 22. The skid-proof section 22 includes a first end 221 near the insert 21 and a second end 222 opposite to the first end 221.

The tube 20 axially defines a tunnel including a first section 223, a second section 224 in communication with the first section 223 and a third section 225 in communication with the second section 224. The diameter of the first section 223 is smaller than that of the second section 224 so that a shoulder 226 is formed between them. The diameter of the second section 224 is larger than that of the third section 225 so that a shoulder 227 is formed between them. The third section 225 is funnel-shaped. The insert 21 defines, along a radius, an aperture 212 in communication with the first section 223.

The pin 30 defines a recess 311 near an end 31 and a groove 321 near an opposite end 32. The recess 311 includes a floor, a slope 313 at an end of the floor and an upright wall 312 at an opposite end of the floor.

The detent 50 is preferably a ball. The elastic element 60 is preferably a helical spring. The clip 70 is preferably a C-clip.

The elastic element 40 is inserted in the second section 224. The clip 70 is positioned in the groove 321. The pin 30 is inserted in the tube 20 and the elastic element 40. Because of the funnel-shaped third section 225, the clip 70 is compressed and forced into the second section 224. Once in the second section 224, the clip 70 expands and retains the pin 30 and the elastic element 40 in the tube 20. The elastic element 40 is compressed between the shoulder 226 and the clip 70.

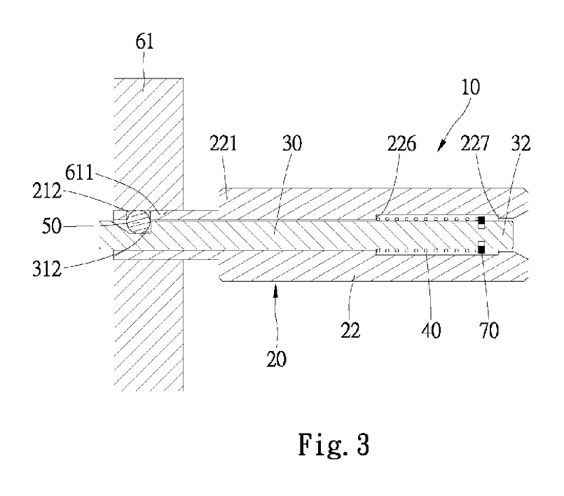

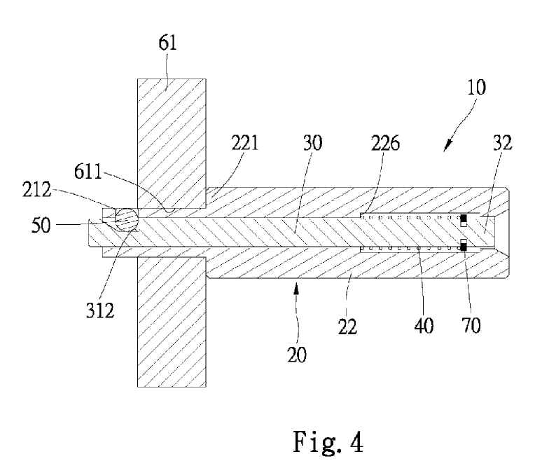

Referring to FIGS. 3 and 4, the second end 32 of the pin 30 is pushed while the elastic element 40 is compressed. Thus, the recess 312 is aligned with the aperture 212. The detent 50 is completely positioned in the aperture 212 and the recess 311. The insert 21 and the detent 50 are inserted in the aperture 611 from a side of a prong of the prong 61 so that they are exposed from an opposite side of the prong of the prong 61.

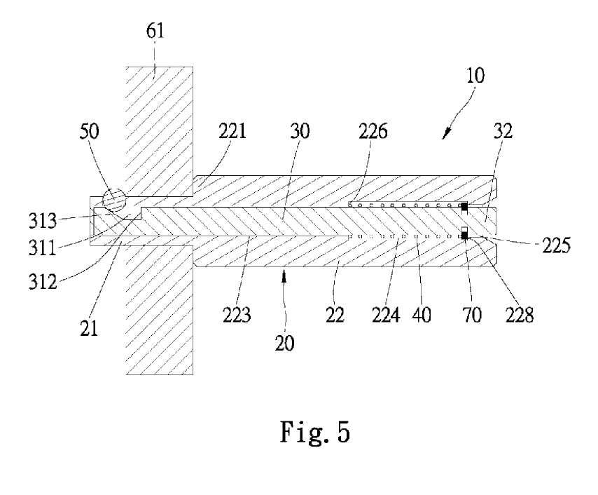

Referring to FIG. 5, the second end 32 of the pin 30 is released. The pin 30 is returned to its normal position by the elastic element 40. The slope 31 3 pushes the detent 50 so that the detent 50 sticks from the aperture 212 and retains the footrest 10 on the prong of the prong 61.

To detach the footrest 10 from the prong of the prong 61, the second end 32 of the pin 30 is pushed so that the detent 50 completely retreats into the aperture 212 and the recess 311 and allows the pulling of the insert 21 from the aperture 611.

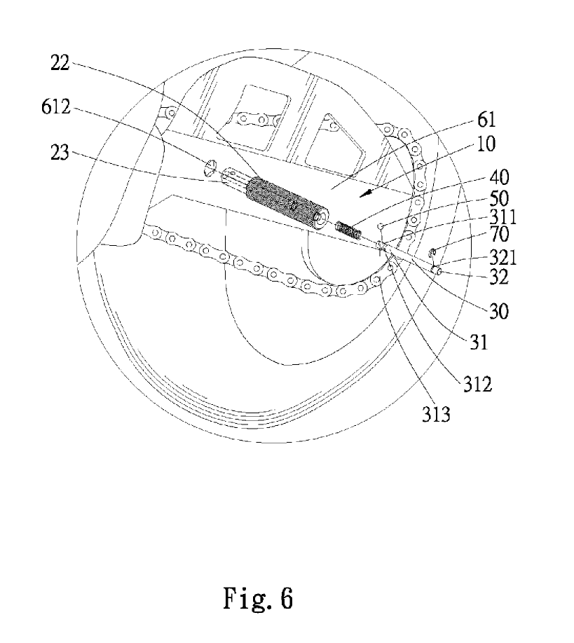

Referring to FIG. 6, there is shown a footrest 10 according to a second embodiment of the present invention. The second embodiment is like the first embodiment except that the tube 20 includes an insert 23 instead of the insert 21. The insert 23 includes a square cross-sectional form instead of the circular cross-sectional form of the insert 21. Accordingly, the prong 61 defines a square aperture 612 for receiving the insert 23 so that the insert 23 cannot be rotated in the aperture 612.

The primary advantage of the footrest according to the present invention is the convenience in installing and uninstalling without the need of using tools.

The present invention has been described via the description of the embodiments. Those skilled in the art can derive variations from the embodiments without departing from the scope of the present invention. Therefore, the embodiments shall not limit the scope of the present invention defined in the claims.

What is claimed is:

1. A footrest comprising:
a tube comprising an insert, a skid-proof section formed together with the insert, a tunnel defined therein and an aperture in the insert so as to be in communication with the tunnel;
a pin comprising a recess defined therein between a slope and an upright wall;
a detent positioned in the aperture and the recess, wherein the pin is movable in the tunnel between a first position where the slope pushes the detent so that the detent sticks from the aperture and a second position where the detent retreats in the aperture and the recess so that insert and the detent can be inserted through an aperture defined in a prong of a portion of a vehicle.

2. The footrest according to claim 1 wherein the insert includes a circular cross-sectional form.

3. The footrest according to claim 1 wherein the insert includes a square cross-sectional form.

4. The footrest according to claim 1 comprising an elastic element between the tube and the pin for pushing the pin to the first position.

5. The footrest according to claim 4 wherein the elastic element is positioned in the tunnel of the tube.

6. The footrest according to claim 5 wherein the tube comprises a shoulder on the wall of the tunnel for abutment against the elastic element.

7. The footrest according to claim 4 comprising a clip installed on the pin and abutted against the elastic element.

8. The footrest according to claim 7 wherein the clip and the spring are positioned in the tunnel of the tube.

9. The footrest according to claim 8 wherein the tube comprises a shoulder on the wall of the tunnel for abutment against the clip.

10. The footrest according to claim 9 wherein the tube comprises another shoulder on the wall of the tunnel for abutment against the elastic element.

11. The footrest according to claim 10 wherein the tunnel comprises an enlarged section between the shoulders.

12. The footrest according to claim 9 wherein the tunnel comprises a funnel-shaped section for compressing the clip so that the clip can be moved past the shoulder.

13. The footrest according to claim 7 wherein the pin comprises a groove for receiving the clip.
